(19) United States
(12) Patent Application Publication
(10) Pub. No.: US 2015/0213405 A1
(43) Pub. Date: Jul. 30, 2015

(54) METHODS AND SYSTEMS FOR FACILITATING DOCUMENT TRANSACTIONS

(71) Applicant: Xerox Corporation, Norwalk, CT (US)

(72) Inventors: Anirban Mondal, Bangalore (IN); Kovendhan Ponnavaikko, Chennai (IN); Koustuv Dasgupta, Bangalore (IN); Deepthi Chander, Cochin (IN); Atul Singh, Bangalore (IN); Nischal Murthy Piratla, Fremont, CA (US)

(73) Assignee: Xerox Corporation, Norwalk, CT (US)

(21) Appl. No.: 14/168,209

(22) Filed: Jan. 30, 2014

(51) Int. Cl. G06Q 10/10

(52) U.S. Cl. CPC G06Q 10/10

(57) ABSTRACT

Some embodiments are directed to document banking systems and methods for facilitating service to an account holder. A document banking system includes a receiver for receiving a service request from the account holder and a service point manager for maintaining information about registered service points and service(s) provided by them. The document banking system also includes a location manager for maintaining information about location of the account holder. The system further includes a transaction engine for identifying a service point based on the service request and the location of the account holder; adding document(s) required for processing the service request in a document transfer queue of the service point; generate and provide a reference number to the account holder; and transfer the document(s) to a document account of the service point based on one or more conditions to prompt the service point to provide the service based on the document(s).

### TECHNICAL FIELD

The presently disclosed embodiments relate to document banking, and more particularly, to methods and systems for facilitating trusted document transactions.

### BACKGROUND

Consumers are often required to submit a significant number of documents to organizations for various reasons, such as for purchasing services, submitting applications, etc. These documents are not available in a single central repository, and instead are typically in paper form or in stored electronic repositories, such as consumers' email account(s). Some of the required documents may even be lost or unavailable.

In one exemplary scenario, if a consumer wishes to apply for a United States (U.S.) visa, then the consumer needs to submit a set of documents (e.g., passport, address proof, bank account statement, photo, etc.) to the U.S. Embassy. In the related art, the consumer will first manually gather the original or certified copies of these documents by accessing different sources (such as, a government office, real estate agency, bank, etc.), and then submit the gathered documents to the U.S. Embassy in person or by mail. This process is cumbersome, time-consuming, inefficient, and/or error prone. Further, it causes human stress as well as a loss in productivity.

Additionally, manual document submissions also stress organizational resources and hinder organizational productivity, in addition to prolonging business process completion times. For example, upon receiving the documents from the consumer, the U.S. Embassy's personnel would need to check the documents and determine their veracity. Again, this process is cumbersome and time-consuming, and may require crosschecking with the organizations that issued these documents.

In some cases, the consumer may proactively maintain scanned copies of all required documents in a document repository service (e.g., Dropbox®, Gmail®) or on the consumer's own computer. However, in general, these scanned copies would still need to be authenticated/certified/duly notarized before they can be submitted to the requesting organization (e.g., U.S. Embassy). Therefore, this scenario still results in human stress and loss in productivity for both the consumer and the requesting organization.

It may therefore be beneficial to provide systems and methods that facilitate a user's: 1) understanding of the documents required for a certain transaction, 2) determination as to the user's accessibility of the required documents, and/or 3) submission of the documents.

### SUMMARY

An embodiment is a system for facilitating at least one service to at least one account holder. The system includes a receiver for receiving at least one service request from the at least one account holder. The system also includes service point manager configured to maintain information about a number of service points along with one or more services provided by each of the service points. Each of the service points is registered and has an associated document banking account. The system also includes a location manager for maintaining information about location of the at least one account holder with a given region-based granularity. The system also includes a transaction engine for identifying at least one service point based on the at least one service request and the location of the at least one account holder; adding at least one document required for processing the service request in a document transfer queue of the at least one service point; generating and providing a reference number to the at least one account holder; and transferring the at least one document to a document account of the at least one service point. The transfer of the at least one document is initiated based on one or more conditions to prompt the at least one service point to provide the service based on the at least one document.

Another embodiment is a document banking system for facilitating at least one service to at least one account holder. The document banking system includes a service request receiver for enabling the at least one account holder to search for a service and receiving at least one service request from the at least one account holder. The document banking system further includes a service point manager for maintaining information about a number of service points and one or more services provided by each of the plurality of service points, wherein each of the plurality of service points is registered with the document banking system. The document banking system also includes a location manager for maintaining information about location of the at least one account holder with a given region-based granularity. The document banking system also includes a transaction engine for suggesting at least one service point based on the at least one service request and the location of the at least one account holder; facilitating at least one document transaction based on the at least one service request; adding at least one document required for processing the service request in a document transfer queue of at least one service point of the service points; generating and providing a reference number to the at least one account holder; and transferring the at least one document associated with the at least one account holder to an account holder to an account of at least one service point. The transfer of the at least one document is initiated based on one or more rules to prompt the at least one service point to provide the service based on the at least one document.

A yet another embodiment is a method for facilitating at least one service to at least one account holder through a document banking system. The method includes maintaining information about a plurality of service points along with one or more service provided by each of the plurality of service points, wherein each of the plurality of service points is registered with the document banking system; receiving at least one service request from the at least one account holder; identifying at least one service point based on the at least one service request and the location of the at least one account holder; displaying the at least one service point along with one or more services and at least one document required for processing the service request along with the availability status within the document banking system; adding at least one document required for processing the service request in a document transfer queue of the at least one service point; generating and providing a reference number to the at least one account holder; and transferring the at least one document to a document banking account of the at least one service point, wherein the transfer is initiated based on one or more rules, to prompt the at least one service point to provide the service based on the at least one document.

A further embodiment is a method for facilitating at least one service to at least one account holder through a document banking system. The method includes maintaining, by a service point manager, information about a plurality of service points along with one or more service provided by each of the plurality of service points, wherein each of the plurality of service points is registered with the document banking system; maintaining, by a location manager, information about location of the at least one account holder with a given region-based granularity; receiving, by a receiver, at least one service request from the at least one account holder; identifying, by a transaction engine, at least one service point based on the at least one service request and the location of the at least one account holder; displaying, by a display module, the at least one service point along with its associated services; adding, by the transaction engine, at least one document required for processing the service request in a document transfer queue of the at least one service point; generating and providing, by the transaction engine, a reference number to the at least one account holder; and transferring, by the transaction engine, the at least one document to a document banking account of the at least one service point, wherein the transfer is initiated based on one or more rules, to prompt the at least one service point to provide the service based on the at least one document.

A yet another embodiment is a method for facilitating document transaction through a document banking system. The method includes receiving a service request from a first account holder; identifying at least one second account holder capable of processing the service request in a location associated with or specified by the first account holder; identifying one or more documents along with their availability in the document banking system. The documents are associated with the first account holder and are required for processing the service request; adding the one or more documents in a document transfer queue of the second account holder; and transferring the at least one document in a document banking account of a second account holder based on one or more rules. The first account holder and the second account holder are registered with the document banking system.

### BRIEF DESCRIPTION OF THE DRAWINGS

FIG. 1 illustrates an exemplary overall system in which various embodiments of the present disclosure may be practiced.

FIG. 2 illustrates system elements of a document banking system, according to an embodiment of the present disclosure.

FIG. 3 illustrates an exemplary interface for accessing the document banking system, according to an embodiment of the disclosure.

FIGS. 4A-4B are flowcharts illustrating a method for facilitating at least one service to at least one account holder though a document banking system, according to an embodiment of the disclosure.

FIGS. 5A-5F are snapshots of a display screen of a mobile device when an account holder accesses a service via a document banking application, according to an exemplary embodiment of the disclosure.

FIG. 6 illustrates an exemplary DocR-tree data structure for storing one or more documents of a number of account holders in a document banking system, according to an embodiment of the disclosure.

FIG. 7 illustrates another exemplary DocR-tree structure, according to another embodiment of the disclosure.

FIG. 8 illustrates a flowchart of a method for processing an exemplary service request, according to an embodiment of the disclosure.

FIG. 9 illustrates a flowchart of a method for processing another exemplary service request, according to another embodiment of the disclosure.

### DETAILED DESCRIPTION

The following detailed description is provided with reference to the figures. Exemplary, and in some case preferred, embodiments are described to illustrate the disclosure, not to limit its scope, which is defined by the claims. Those of ordinary skill in the art will recognize a number of equivalent variations in the description that follows.

### DEFINITIONS

Definitions of one or more terms that will be used in this disclosure are described below. The term, “document banking” refers to document storage as well as trusted document transactions between one or more parties. The term “document” refers to any information such as a text, a video, an audio, a fingerprint that can be embedded inside a paper document or an electronic document, etc. Some or all of the operations of document banking are analogous to traditional banking, which stores and transacts money. The term “document transaction” refers to any activity related to documents performed in a document banking system. Examples of document transactions include, but are not limited to, opening a new document account, depositing a document in the document account, verifying a document, sending one or more documents through a gateway, sending a document periodically to a beneficiary, receiving a document from the document account, deleting a document, updating an existing document and adding an account holder to a list of beneficiaries to send documents to the account holder.

The term “transaction engine” refers to a device or a software module within the document banking system that processes all document transactions. The transaction engine may execute predefined functions corresponding to the one or more document transactions to process the corresponding document transactions. The term “billing and payment module” refers to a device or a software module within the document banking system to handle billing and payment activities. Similarly, the term “logging module” refers to a device or a software module within the document banking system to log the result of each document transaction.

The term “account holder(s)” refers to any individual or entity that maintains a document account with a document banking system. The term “storage repository” refers to any storage space available at a document banking system to store documents. Each account holder is allocated a pre-defined space within the storage repository, wherein the pre-defined space is associated with the document account of the account holder. The storage repository also stores a “profile database (DB)” to store information related to the account holders. Further, the storage repository stores documents in a predefined format, such as PDF, DOC, JPEG, MPEG, etc. The term “secure data technologies (SDT) module” refers to a device or a software module within the document banking system that secures and authenticates the documents stored in the storage repository.

As used herein, the term “verification partners” refers to individuals or organizations who have the authority to certify the veracity of documents. The verification partners include public offices (e.g., Passport and Immigration Office, Income Tax Department, Motor Vehicles Department), private offices (e.g., banks, hospitals, schools) as well as other offices or officials (e.g., gazette officers and notarization services). As used herein, the term “verification module” is a device or a software module within the document banking system that manages verification related activities at the document banking system. Once a document is verified, a “verified tag” is associated with the document.

The term “gateway” refers to a communication channel used by third parties to connect account holders with their respective document accounts with a document banking system. The term “token” refers to a unique identifier generated by third parties. In some cases, the term “token” refers to a unique identifier generated by the document banking system and sent to an account holder to confirm an action (such as deleting or modifying of a document) initiated by the account holder.

### Overview

Some disclosed embodiments generally relate to trusted document transactions between one or more parties via a document banking system. The one or more parties include account holders, service points, verification partners, etc. To this end, the disclosure provides a document banking system that includes a repository for storing the account holders' documents (e.g., passport, driver's license, photos and/or videos or others) in a document account, and enables account holders to transact or transfer these documents to other accounts as and/or when requested for requesting or availing one or more services. For example, an account holder can efficiently send her document(s) from her document account to an intended recipient's document account or to a service point's document banking account, e.g., a bank, a hotel, a college, and so forth.

Document transactions involve authenticating the identities of the sending and the receiving parties, and verifying the document(s) being transacted. This enhances or ensures integrity as well as non-repudiation in sending or receiving of document(s) across, between, or among the concerned parties. Thus, some of the disclosed embodiments relate to business processes, systems and methods that allow a given account holder to perform trusted document transactions via a document banking system.

### Overall Exemplary System

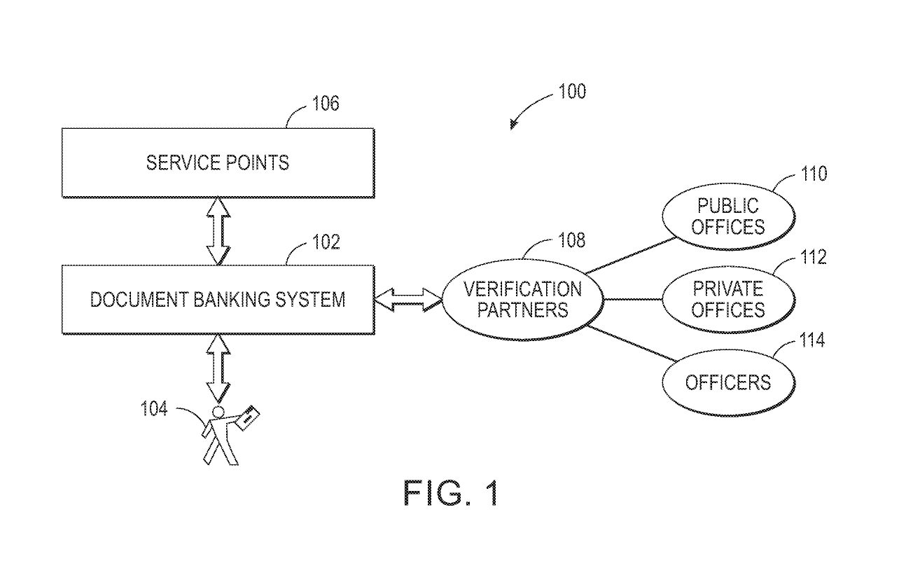

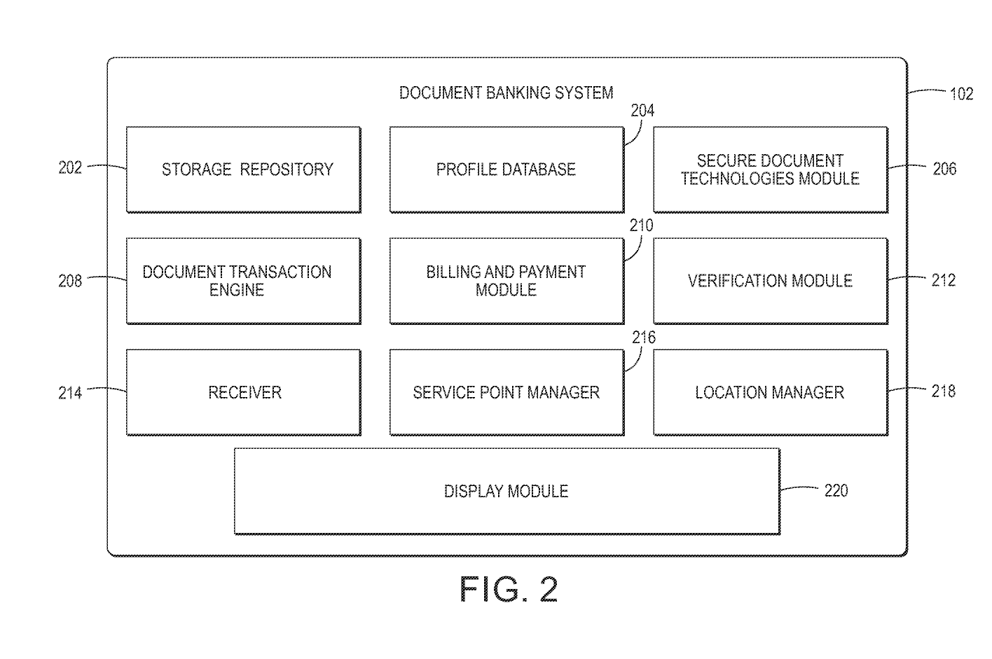

FIG. 1 illustrates an overall exemplary system 100 in which various of the disclosed embodiments may be practiced. The system 100 includes a document banking system 102, which facilitates document transactions among various account holders registered with the document banking system 102. In an embodiment, the document banking system 102 is hosted on a server. The architecture of the document banking system 102 is explained in further detail in conjunction with FIG. 2 below.

One or more individuals and one or more business(es)/organization(s) (hereinafter, collectively referred as at least one account holder 104) may have document accounts with the document banking system 102. The at least one account holder 104 of the document banking system 102 may interact with the document banking system 102 to perform various types of document transactions. Various examples of document transactions include, but are not limited to, opening a new document account, depositing a document in the document account, requesting a service, searching for a service, verifying a document, sending a document through a gateway, sending a document periodically to a beneficiary, receiving a document from the document account, deleting a document, updating an existing document, adding an account holder to list of beneficiaries to send documents to the account holder, etc.

The system 100 may also include a number of service points 106 capable of providing one or more services to the at least one account holder 104. Examples of the service points may include, but are not limited to, banks, hotels, hospitals, schools, colleges, passport offices, and so forth. The services may be one or more services directly or indirectly provided to the account holder 104 by the service points 106. For example, a bank may provide services such as, opening a bank account, applying for a loan, demat service, and so forth.

A given document transaction may be any known, related art, or later developed form, such as in any one of the following forms: Consumer-To-Business (C2B), Business-To-Consumer (B2C), Consumer-To-Consumer (C2C) and Business-To-Business (B2B). An example of a C2B document transaction is an individual sending her resume to a company in order to apply for a job. An example of a B2C document transaction is a company sending a job offer to a job applicant. An example of a C2C document transaction is a house owner sending a lease agreement to the tenant. An example of a B2B document transaction is a company sending financial documents to a bank for applying for a loan. The document transactions as described here are exemplary in nature and are not intended to limit the scope of the disclosure.

The document banking system 102 may communicate with or access at least one verification partner 108 to verify documents stored in the document banking system 102. The at least one verification partner 108 includes public offices 110, private offices 112 as well as other offices or officials 114. The document banking system 102 establishes interactions with the at least one verification partner 108, either via a web-based API or manually, thereby enabling verification of any given account holder's documents. The at least one account holder and the service points 106 may register with the document banking system 102 and create a document account within the document banking system 102. After registration, the at least one account holder 104 and the service points 106 may upload or download documents from their respective account. Alternatively, the at least one account holder 104 and the service points 106 may download documents from a third party's account. The document banking system 102 may also provide a storage to all its registered account holders such as the at least one account holder 104 and the service points 106.

FIG. 2 illustrates various system elements of the document banking system 102, according to one embodiment of the present disclosure. The document banking system 102 includes a storage repository 202, a profile DataBase (DB) 204, a Secure Document or data Technologies (SDT) module 206, a document transaction engine 208, a billing and payment module 210, a verification module/system 212, a receiver 214, a service point manager 216, a location manager 218, and a display module 220. These modules interact with each other to perform and accomplish a desired task.

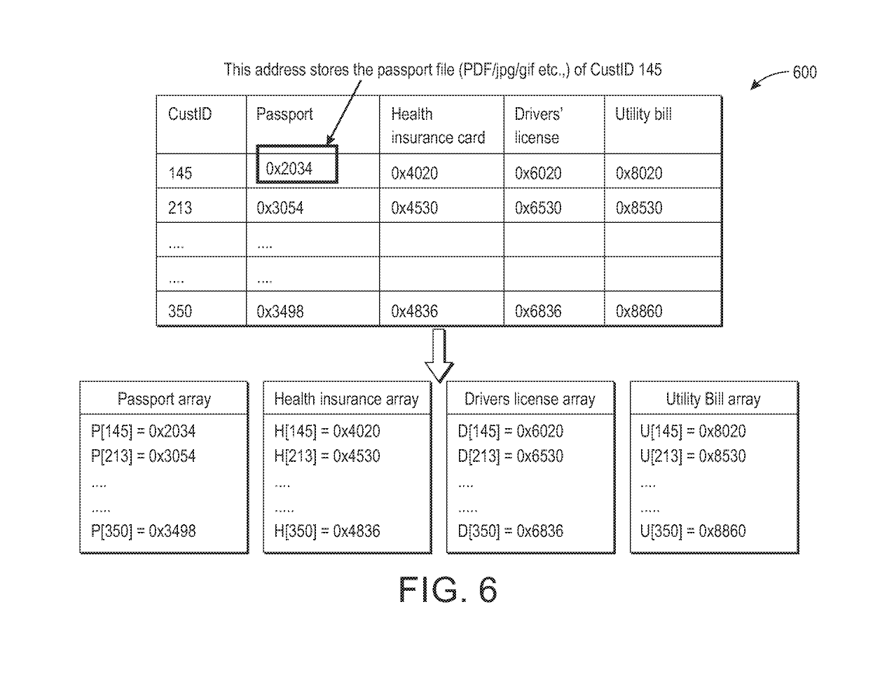

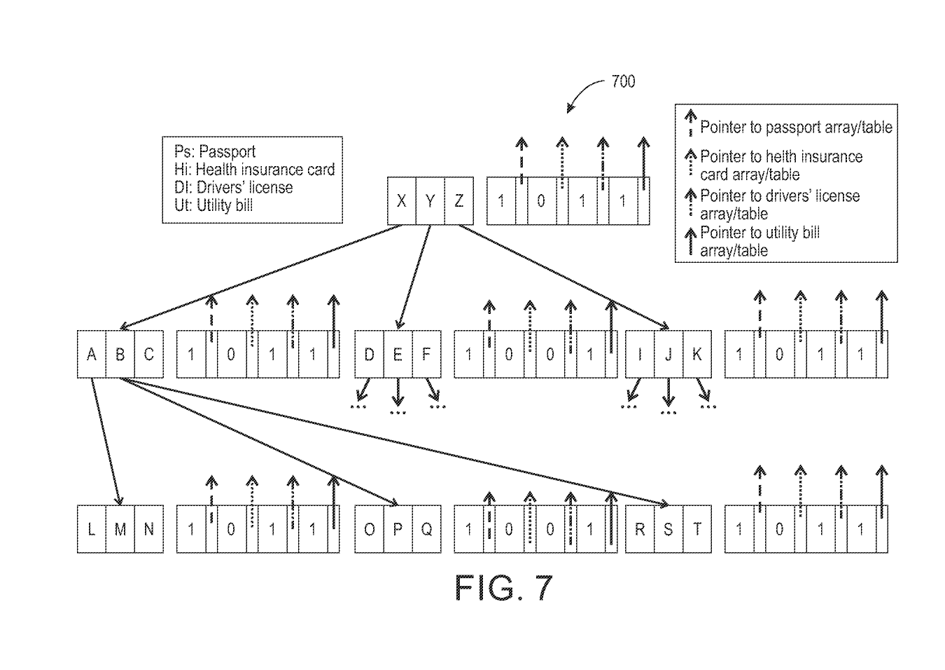

The storage repository 202 may store documents of the at least one account holder 104 in a reliable and secure manner using one or more known, related art or later developed technologies. For example, the storage repository 202 may allow access only through a firewall to enhance or ensure secure access. Further, the storage repository 202 may employ antispyware and anti-virus programs to enhance or ensure data integrity and security. Moreover, the documents may be stored in a pre-defined format. In an embodiment, the documents are stored using DocR-tree data structure as discussed in detail with regard to FIGS. 6 and 7.

The profile DB 204 may store account information of the at least one account holder 104; for example, login credentials, beneficiary list and other related information. The SDT module 206 helps in authenticating the documents and storing the documents in a pre-defined format in the storage repository 202. The SDT module 206 may use one or more known, related art or later developed technologies, for example, encryption, to authenticate documents and store them in an encrypted form. The document authentication ensures that documents cannot be modified inadvertently or reduces such inadvertent modification.

The service point manager 216 may maintain information about a plurality of service points 106 along with one or more services that the service points 106 may provide. The service point manager 216 may maintain the information using the DocR-tree data structure. The service points 106 are the registered account holders with the document banking system 102. The service point manager 216 may also store information about spatial locations on a map of the plurality of service points 106. Further, the registration of a new service point or addition of a new service by an existing registered service point may be provided via the service point manager 216.

The location manager 218 maintains information about respective location of the at least one account holder with a given region-based granularity. The location manager 218 may keep track of the respective locations of the account holder 104. For example, the granularity of the region may be 50 meters by 50 meters, or 1 Km by 1 Km, and so on. The optimal granularity to be used may depend essentially upon spatial density of the region. Further, the location manager 218 may keep track of the locations or movements of only those users or account holders who have subscribed to this service and launched the document banking application on their device. Hence, whenever the account holder 104 launches the document banking application on his/her device, a trigger may be generated for the location manager 218 and it may start tracking the movements of the account holder 104. The tracking may end once the account holder closes the document banking application on the device.

The at least one account holder 104 may access the document banking system via a document banking application running at an associated device or via entering a universal resource locator (URL) in a browsing application at the device. The document banking application may be an interface for allowing the at least one account holder 104 to access the document banking system 102. When the document banking application is on at the device, then the location manager 218 keeps on tracking the location of the at least one account holder 104 in real time. The location manager 218 may stop tracking the location of the at least one account holder 104 when the document banking application is closed on the device.

The document transaction engine 208 may facilitate one or more document transactions among various parties including the at least one account holder 104, the service points 106, the at least one verification partner 108, third parties, etc. The transaction engine may also process the received at least one service request. The transaction engine may also identify at least one service point from the multiple service point based on the at least one service request and/or the respective location of the at least one account holder 104. The at least one service point 106 is capable of providing the service requested in the service request. The transaction engine 208 may also add at least one document required for processing the service request in a document transfer queue of the at least one service point 106. The document transaction engine 208 may also generate and provide a reference number to the at least one account holder 104. Further, based on one or more rules or predefined conditions as specified by the at least one service point, the transaction engine may transfer the at least one document to an account of the at least one service point 106. The transfer of the at least one document may be initiated based on the rules. Further, the transaction engine 208 may manage and supervise the at least one document transaction occurring in the mobile settings of a mobile device, for example.

The display module 220 may display content or information to the user. For example, the display module 220 may display the at least one service point 106 along with the associated services and other information including one or more service options to the at least one account holder 104. The service options may be an option to allow the at least one account holder 104 to download a copy of the documents, or to add the documents to a document transfer queue of the at least one service point 106.

In some scenarios, the at least one account holder may need to visit a branch office of the at least one service point 106 for further verification. The documents may only be transferred from the document transfer queue to the document banking account of the at least one service point 106 after verification.

The billing and payment module 210 handles billing related activities associated with the one or more document transactions. When or if requested, the verification module 212 performs verification of the documents, either manually or via a web-based API.

The document banking system 102 also includes a notification module to notify the at least one account holder 104 of account activity related to one or more document transactions. Moreover, the document banking system 102 includes a logging module to log information related to all activities performed on the document banking system 102. The logged information may be used to perform system performance analytics to facilitate reasonable document transaction response times as well as system scalability with respect to a large and/or growing number of account holders and an increasingly large number of transactions. The statistics obtained by the performance analytics may include average time taken for different types of transactions, most frequently requested transactions, etc. The obtained statistics may be available to the document banking system 102 so that it may take corrective actions to maintain reasonable system performance. In some embodiments, the document banking system 102 may also include a scanner to scan documents and a printer to print documents.

In an exemplary embodiment, the at least one account holder 104 logs into the document banking system 102. The document banking system 102 uses the profile DB 204 to verify the login credentials of the at least one account holder 104 before the at least one account holder 104 is allowed to access the document account at the document banking system 102. Thereafter, the at least one account holder 104 initiates a document transaction, such as a deposit document transaction, and sends a document to the document transaction engine 208. The document transaction engine 208 processes the deposit document transaction as per the predefined functionality. Thereafter, the SDT module 206 authenticates the document sent by the at least one account holder 104 and stores an encrypted copy of the document in the storage repository 202. In some embodiments, the billing and payment module 210 updates billing information for the at least one account holder 104 based on the type of the document transaction.

In cases where the at least one account holder 104 initiates a request for verifying a document, the verification module 212 identifies a relevant verification partner, in the at least one verification partner 108, to verify the document. If successfully verified, the verification module 212 sets a “verified_tag” associated with the document to “TRUE”. Finally, the billing and payment module 210 updates billing information for the at least one account holder 104 based on the verified document transaction.

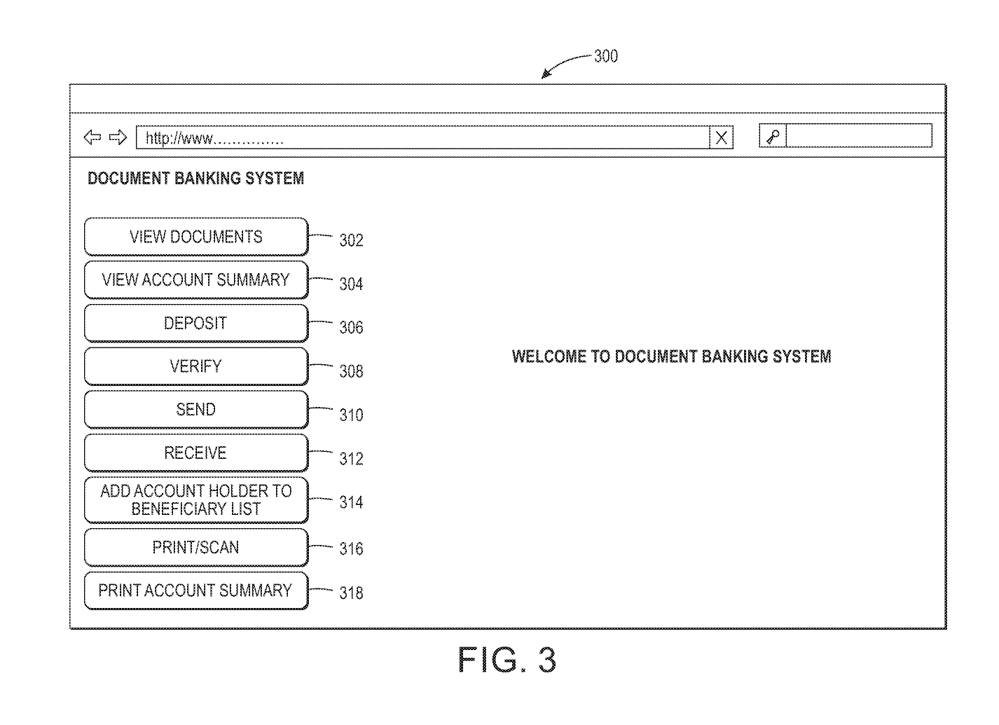

FIG. 3 illustrates an exemplary interface for accessing the document banking system 102 on a device used by an account holder “S”, according to an embodiment of the disclosure. The snapshot 300 shows a user interface that includes multiple buttons 302-318 related to various transactions that may be performed using the document banking system 102. The account holder “S” may activate:
1. “view documents” button 302 to view one or more documents stored in the document account
2. “view account summary” button 304 to view the account summary
3. “deposit” button 306 to deposit one or more documents into the document account
4. “verify” button 308 to verify one or more documents into the document account
5. “send” button 310 to send one or more documents to at least one account holder
6. “receive” button 312 to receive one or more documents available in a public space
7. “add account holder to beneficiary list” button 314 to add at least one account holder to a beneficiary list
8. “print/scan” button 316 to print or scan one or more documents
9. “print account summary” button 318 to print account summary

For a person skilled in the art, it is understood that the user interface as shown is exemplary in nature and should not limit the scope of the disclosure.

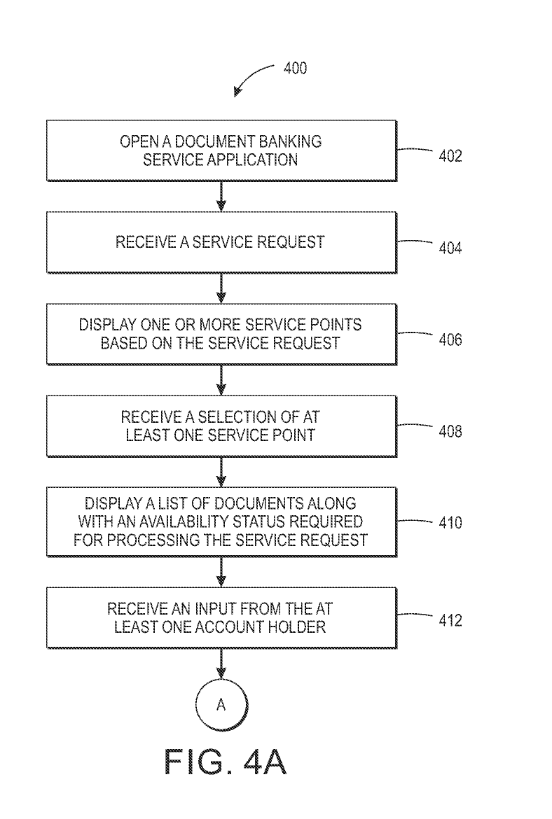

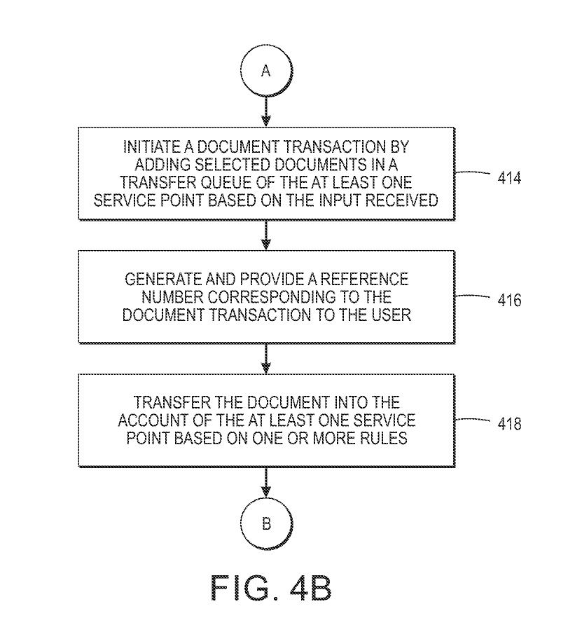

FIGS. 4A-4B illustrate a flowchart of a method for facilitating at least one service to at least one account holder 104 through the document banking system 102, according to an embodiment of the present disclosure.

At step 402, the at least one account holder 104 accesses the document banking system 102 or opens a document banking application on its associated device. Then, at step 404, a service request is received by the receiver 214 based on one or more search entries received from the account holder 104. The service request may be based on a search performed by the at least one account holder 104 using the banking application. In an embodiment, the at least one account holder may specify or request for a service based on its own location.

At step 406, the display module 220 displays one or more service points 106 along with the service provided by the service points based on the service request. Then, the at least one account holder 104 may select at least one of the service points 106. The receiver 214 may receive the selection of the at least one service point 106 at step 408.

Next at step 410, the display module 220 displays a list of documents required for processing the service request. The availability status of the documents within the storage repository 202 of the document banking system 102 is also displayed at step 410.

Then at step 412, an input regarding a service option is received from the at least one account holder 104. The service option(s) may be displayed to the account holder 104. The service option(s) may include downloading a copy of the documents, uploading the unavailable documents, adding the documents in a document transfer queue of the at least one service point 106. When the input is a selection of the service option including adding of the documents in the document transfer queue, then at step 414, a document transaction is initiated. The document transaction may be initiated by adding the one or more documents in the document transfer queue of the at least one service point 106. Then at step 416, a reference number is generated corresponding to the document transaction and is provided to the at least one account holder 104. In some exemplary scenarios, the account holder 104 may visit a branch office of the at least one service point 106 for further verification or documentation. The verification may happen based on the reference number and one or more additional documents such as, passport, driving license, and so forth. Thereafter, based on one or more rules set or specified by the at least one service point, document(s) may be transferred into a document banking account of the at least one service point 106 at step 418. In alternate embodiments, the transfer of the documents may occur based on some time related rules, for example, the transfer may be scheduled to occur at a future date or time.

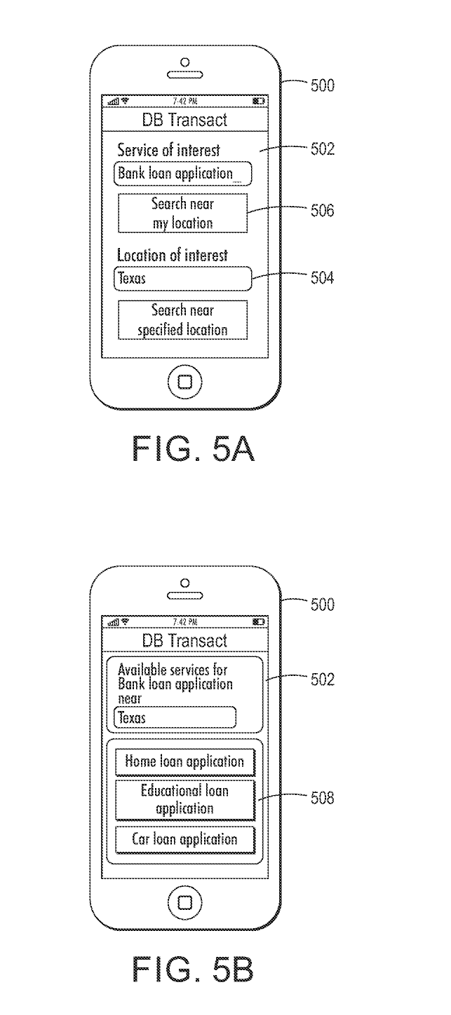

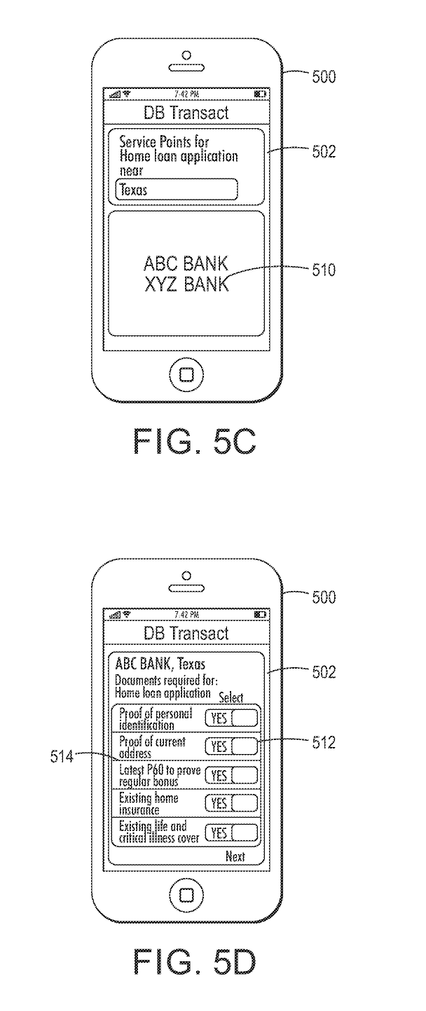

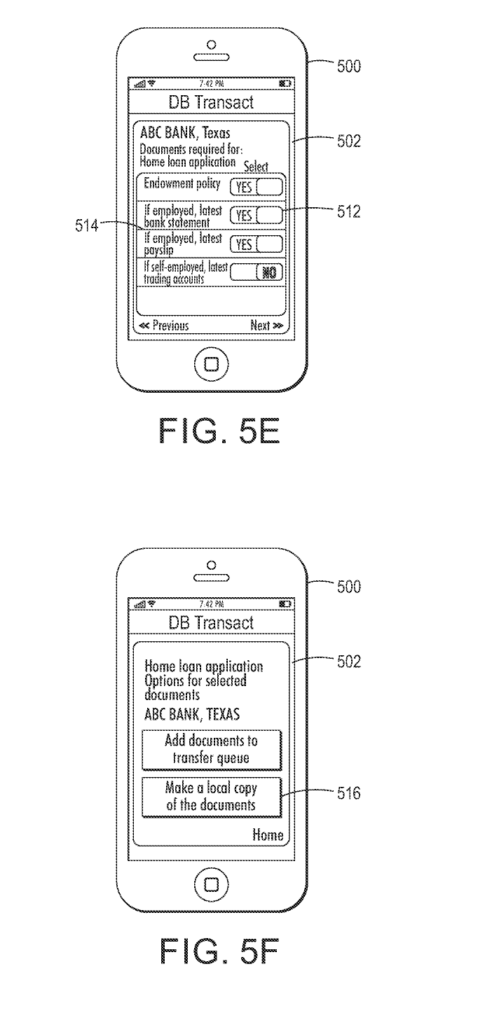

FIGS. 5A-5F illustrate snapshots of a display screen 502 of a mobile device 500 when an account holder accesses a service via a document banking application, according to an exemplary embodiment of the disclosure. As discussed with reference to FIG. 1, the document banking system 102 may be accessed either by typing a URL at a browsing application or through the document banking application running on a device of the account holder.

As shown in FIG. 5A, the at least one account holder 104 can access the document banking system 102 by opening or initiating the document banking application on the mobile device 500. The mobile device 500 may be a smart phone. The document banking application may allow the account holder 104 to search for specific services, such as, a bank loan application submission service. The account holder also has a choice of searching for a service in a location that is in the proximity of current location of the at least one account holder 104 or close to a specified location. The at least one account holder 104 may search for a service by entering one or more details in one or more fields 504 as shown. For example, the account holder 104 may search for a bank loan application submission service in the Texas area. The at least one account holder 104 can initiate the search by clicking or selecting one or more search tabs 506. When at least one of the search tabs 506 is selected, a service request is sent to the receiver 214 of the document banking system 102.

The transaction engine 208 then may identify one or more service points 106 that provide the service based on the service request. As shown in FIG. 5B, the document banking application returns the set of relevant services 508 offered in the specified location. The one or more services 508 are displayed at a display 502 of the mobile device 500. The at least one account holder 104 may select a service from the displayed services 508. Based on the selection of the service, the transaction engine 208 may identify one or more service points 106 capable of providing the selected service to the at least one account holder 104. On selecting by the account holder 104 at least one service, the document banking application returns the a list 510 including the one or more service points 106 that offer the selected service. The list 510 is displayed at the display 502 as shown in FIG. 5C.

Turning now to FIG. 5D, choosing at least one service point 106 by the at least one account holder 104 displays a list of required documents 514 and their availability status 512 within the data banking system 102 (or the storage repository 202). As shown in FIG. 5E, a “Yes” besides a given required document indicates that based on tag or previous learning, the document banking system 102 knows that this specific document is present in the document account of the at least one account holder 104 (or first account holder). For example, if a proof of personal identification document is present in the document banking account of the account holder 104, then a “Yes” appears beside it.

A suitable indication such as “No” appears beside a required document that is unavailable within the document banking system 102, as shown in FIG. 5F. For example, if a document corresponding to the “If Self Employed, latest trading accounts” document is unavailable, then a “No” appears besides it. In an embodiment, “√” or “x” may be used for indicating availability and unavailability of the required documents 514 in the document banking account of the account holder 104.

As shown in FIG. 5G, the account holder 104 can choose to do one or several steps, which are displayed as one or more service options 516 on the display 502. Examples of the service options 516 may include, but not limited to, downloading or making a local copy of the documents at the mobile device 500, or initiating a transaction by adding them to a transfer queue (or a document banking queue) of at least one service point 106 (or second account holder). The transfer queue is a concept of a standby pool, where the account holder 104 may partially complete a document transaction and then get a reference number as generated by the transaction engine 208. The reference number is provided to the at least one account holder 104. In an embodiment, for security reasons, the validity of the transfer queue can be limited for a certain time. This may be helpful if the account holder 104 is not sure of the documents, and also uncertain of the service point 106, or the service point 106 is not ready to receive the documents until the account holder 104 visits a branch office of the service point 106.

In an embodiment, the at least one account holder 104 may visit the branch office of the service point 106 and convey the reference number along with additional security information or documents, such as but not limited to, DoB certificate, Maiden Name, etc. The service point 106 then may initiate or receive the document from the transfer queue to its document banking account. In alternate embodiment, physical visit of the account holder 104 at the branch office of the service point 106 may not be required. In another embodiment, the actual transfer of documents into the document banking account (or account) of the service point 106 may be initiated based on one or more rules/conditions. The one or more rules may be set or specified by the service point 106. The rules may be time bound or time based, or may be based on a security code, which the account holder 104 may receive from the service point 106. For example, a time based rule may be transferring the documents in document banking account of the at least one service point 106 at a predefined time and/or date, such as on February 24 at 6 AM (PDT).

In case of a security code based rule, the at least one account holder 104 may receive the security code by visiting the at least one service point 106. The at least one service point 106 may provide the security code post verification of one or more verification documents provided by the at least one account holder 104. Examples of the verification documents may be, but not limiting to, original documents of driver's license, a social security number, a passport, and so forth.

FIG. 6 illustrates an exemplary DocR-tree data structure 600 for storing one or more documents of a number of account holders in the document banking system 102, according to an embodiment of the disclosure. The DocR-tree structure 600 is a spatial indexing structure for enabling a service points-based document recommendation system. In particular, the DocR-tree structure 600 pertains to, as well as indexes, a specific service that is offered by a given set of service points 106. An example of the service may be a mortgage application submission, and it may be offered by multiple banks, i.e., the service points 106 in the space being indexed by the DocR-tree 600. In other words, for different services, the entries may be populated into the DocR tree 600 that is being indexed by the document banking system 102. In addition, for different services, the entries populated into the DocR-tree 600 may be different due to varying document requirements across services, thereby different DocR-tree 600 may be required, one for each service that is being indexed by the document banking system 102. As a single instance, the entries in a DocR-tree 600 for a mortgage application submission use-case scenario may very likely be different from the corresponding entries in a health insurance application submission use-case scenario.

As shown, the DocR-tree 600 may use a set of arrays, wherein one array is provided for each type of document that it indexes. Examples of the type of the document may include a passport, health insurance, driver's license, etc. Therefore, for indexing N different types of documents, the DocR-tree 600 includes N such arrays. In the DocR-tree 600 as shown, the ith entry of a given array may contain a pointer to the corresponding document of the customer or the account holder 104 with ID “i”. For example, the passport array may be denoted as “P”. The array entry P[350] contains a pointer to the passport of the account holder 104 with ID 350. In an embodiment, the ID of the account holder 104 is numeric and unique. In another embodiment, the ID can be alpha numeric and may be converted into a unique number using a hash function or by removing the alphabetic parts of the ID.

FIG. 7 illustrates another exemplary DocR-tree structure 700, according to another embodiment of the disclosure. FIG. 7 is divided into three rectangular spatial regions X, Y, and Z. As depicted in the figure, {Ps, Hi, Dl, Ut) stand for {Passport, Health Insurance, Driver's License, Utility Bill}, respectively. The bitmap entries of the root node indicate that the entire region may require a passport, a driver's license, a utility bill, but not a health insurance document. Thus, the bitmap entry corresponding to the health insurance document is set to “0” at the root node, but it is set to “1” for all the other document types. For the sake of convenience, this notation is used throughout the figure. The region X is further divided into the spatial regions A, B, C. Similarly, the Y region may be divided into the spatial regions D, E, F, and the Z region is further divided into the spatial regions I, J, K.

Non-leaf nodes of the DocR-tree 700 are of the form (ptr, mbr, bmap), where “ptr” is a pointer to a child node in the DocR-tree 700, and “mbr” is the minimum bounding rectangle, which may cover all the MBRs in that child node. Here, bmap is an array, each entry of which is a bit and a pointer to a document array. The bit is set to “1” if the spatial region covered by that node requires a certain document type, otherwise it may be set to “0” or “Null”. The pointer in each entry of the bmap array points to a specific document array. For example, the document requirement for a region covered by a node marked as XYZ in FIG. 7 may include passport, Driving license, and utility bills; hence, these bits are set to “1” in the bitmap. In addition, the pointers may point to the passport array, driver's license array and the utility bills array, respectively. However, the bit corresponding to health insurance document is set to “0”, thereby implying that the region covered by this node does not require any health insurance document. In such cases, where the bit is set to “0’, the corresponding pointer may point to NULL.

Further, one or more leaf nodes of the DocR-tree 700 may contain entries of the form (SP_id, loc, bmap). The SP_id is a pointer to a specific Service Point in the spatial database and loc is the location (i.e., one set of (x,y) coordinates if the Service Point is a point in the granularity of space being considered, or two sets of (x,y) coordinates if the Service Point is a rectangle in that space) of that service point. The structure of the bmap for the leaf nodes of the DocR-tree 700 is similar or essentially the same as that of the structure of the bitmap for the non-leaf nodes.

Depending on upon the granularity of the region being considered, all of the service points need not necessarily be points in space, i.e., they may be rectangles, etc. Maintaining bitmaps at all levels of the DocR-tree 700 enables the index to work for any given granularity, and may not constrain the applicability of the index because it can handle service points, regardless of whether they are points or rectangles. Further, the DocR-tree 700 may be populated based on information obtained from the service points.

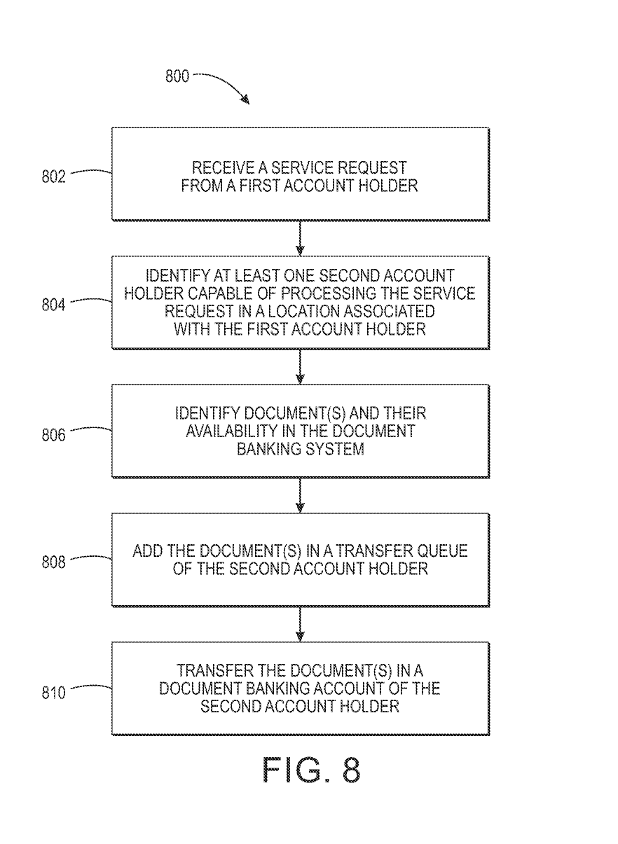

FIG. 8 is a flowchart illustrating a method 800 for processing an exemplary service request, according to an embodiment of the disclosure. As discussed with reference to FIG. 1, the at least one account holder 104 and the service points 106 are registered with the document banking system 102.

At step 802, a service request from a first account holder, i.e., the at least one account holder 104, is received by the receiver 214 of the document banking system 102. The first account holder may also specify a location while searching for a service via the service request. At step 804, the transaction engine 208 may identify at least one second account holder i.e. at least one service point 106, which is capable of processing the service request in a location associated with or specified by the first account holder.

At step 806, one or more documents and their availability in the document banking system are identified and presented to the first account holder. The document banking system 102 then may receive one or more input (or selection of a service option) from the first account holder and perform one or more actions based on the input. At step 808, required documents may be added in a transfer queue of the second account holder. Then at step 810, based on one or more rules, the documents are transferred into a document banking account of the second account holder.

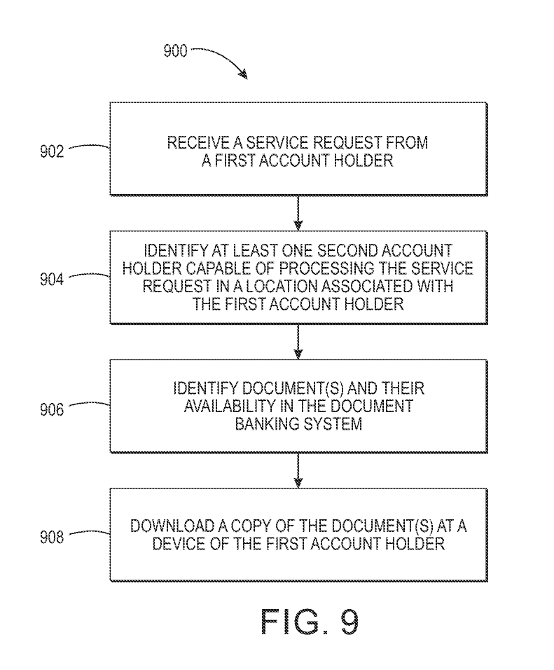

FIG. 9 is a flowchart illustrating a method 900 for processing another exemplary service request, according to another embodiment of the disclosure. As discussed with reference to FIG. 1, the at least one account holder 104, i.e., a first account holder, and the at least one service point 106, i.e., second account holder, are registered with the document banking system 102.

At step 902, a service request from the first account holder is received by the receiver 214 of the document banking system 102. The first account holder may also specify a location while searching for a service via the service request. At step 904, the transaction engine 208 may identify at least one second account holder, which is capable of processing the service request in a location associated with or specified by the first account holder.

At step 906, one or more documents and their availability in the document banking system is identified and presented to the first account holder. The document banking system 102 then may receive one or more input (or selection of a service option) from the first account holder and perform one or more actions based on the input. At step 908, required documents may be downloaded at the device of the first account holder when the first account holder chooses to make a local copy of the documents. The device may be a mobile device.

The functionalities and the transaction model described above can be leveraged towards the realization of typical use-cases of document banking. In particular, these use-cases are realized by a combination of two types of operations, namely transactions and service requests. Each of these types of operations may occur multiple times within the same use-case. A transaction is any operation that relates to documents, e.g., initiating a document transfer, receiving a document, document creation, updates, deletions, etc. Any operation, which is not directly associated with a document, may be defined as a service request, e.g., login request to an account holder's document banking account. An example of a use-case is an account holder depositing a document into her account and requesting for that document to be verified before sending it to the U.S. Embassy through a gateway. In essence, by combining the set of functionalities and service requests in a specific configuration to satisfy some objective (e.g., submitting documents required for a visa), different use-cases for document banking can be provided.

The present disclosure is directed to methods and systems for facilitating document banking in a more secure, trusted, and reliable environment. Particularly, the methods and systems enable account holders to perform transactions related to documents, thereby increasing productivity, and reducing hassles. For example, the account holder can access his document account anytime and use the documents in any desired manner. Further, the disclosed methods and systems enable account holders to perform transactions in a trusted environment by reducing spam transactions. Yet further, the existing infrastructure of banks may be used to implement the disclosed document banking system, wherein the existing banks provide additional services related to document transactions as disclosed above. The existing bank customers may purchase these additional services based on monthly or annual plans offered by the bank.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A document banking system for facilitating at least one service to at least one account holder, the system comprising:
a service request receiver configured to:
enable the at least one account holder to search for a service; and
receive at least one service request from the at least one account holder;
a service point manager configured to maintain information about a plurality of service points along with one or more services provided by each of the plurality of service points, wherein each of the plurality of service points is registered;
a location manager configured to maintain information about location of the at least one account holder with a given region-based granularity; and
a transaction engine configured to:
identify at least one service point based on the at least one service request and the location of the at least one account holder;
add at least one document required for processing the service request in a document transfer queue of the at least one service point;
generate and provide a reference number to the at least one account holder; and
transfer the at least one document to a document account of the at least one service point, wherein the transfer of the at least one document is initiated based on one or more conditions to prompt the at least one service point to provide the service based on the at least one document.

2. The document banking system of claim 1, further comprising a storage repository configured to store one or more documents associated with the at least one account holder, wherein the at least one account holder is registered with the document banking system.

3. The document banking system of claim 1, further comprising a document banking application running on a device associated with the at least one account holder, the document banking application is an interface to allow the at least one account holder to access the document banking system.

4. The document banking system of claim 3, wherein the device is a mobile device, further wherein the transaction engine is configured to manage and supervise the at least one document transaction occurring on the mobile device.

5. The document banking system of claim 4, further comprising a display module configured to display at least one service point along with the associated services and other information including one or more service options to the at least one account holder.

6. The document banking system of claim 5, wherein the one or more service options comprises at least one of download a copy of the at least one document, and add the at least one document to the transfer queue.

7. The document banking system of claim 1, wherein the storage repository stores the one or more documents using DocR-tree data structure, further wherein the service point manager maintains information using DocR-tree data structure.

8. The document banking system of claim 1, wherein the one or more rules are defined by the at least one service point.

9. The document banking system of claim 8, wherein the one or more rules comprises a rule based on at least one of time, a security code issued by the at least one service point, a location of the at least one account holder.

10. The document banking system of claim 9, wherein the transfer of the at least one document occurs post verification of the at least one account holder by the at least one service point.

11. The document banking system of claim 10, wherein the verification of the at least one account holder is performed at a branch office of the at least one service point based on the reference number presented by the at least one account holder.

12. The document banking system of claim 1, wherein the receiver is configured to receive a selection of the at least one service point from the at least one account holder.

13. The document banking system of claim 1, wherein each of the plurality of service points is configured to receive the at least one document from the transfer queue in a document banking account associated with the service point.

14. A method for facilitating at least one service to at least one account holder through a document banking system, the method comprising:
maintaining, by a service point manager, information about a plurality of service points along with one or more service provided by each of the plurality of service points, wherein each of the plurality of service points is registered with the document banking system;
maintaining, by a location manager, information about location of the at least one account holder with a given region-based granularity;
receiving, by a receiver, at least one service request from the at least one account holder;
identifying, by a transaction engine, at least one service point based on the at least one service request and the location of the at least one account holder;
displaying, by a display module, the at least one service point along with its associated services;
adding, by the transaction engine, at least one document required for processing the service request in a document transfer queue of the at least one service point;
generating and providing, by the transaction engine, a reference number to the at least one account holder; and
transferring, by the transaction engine, the at least one document to a document banking account of the at least one service point, wherein the transfer is initiated based on one or more rules defined by the at least one service point, to prompt the at least one service point to provide the service based on the at least one document.

15. The method of claim 14, further comprising initiating a document banking service application on a device associated with the at least one account holder.

16. The method of claim 14, further comprising storing, at a storage repository, one or more documents associated with the at least one account holder, wherein the at least one account holder is registered with the document banking system.

17. The method of claim 16, wherein the one or more documents are stored using DocR-tree data structure, further wherein the information is maintained using DocR-tree data structure.

18. The method of claim 14, further comprising managing and supervising the at least one document transaction occurring on the device by the transaction engine.

19. The method of claim 14, further comprising displaying, by the display module, other information including one or more service options to the at least one account holder.

20. The method of claim 19, wherein the one or more service options comprises at least one of downloading a copy of the at least one document, and adding the at least one document to the transfer queue.

21. The method of claim 14, further comprising transferring, by the transaction engine, the at least one document into the document banking account of the at least one service point post verification of the at least one account holder by the at least one service point.

22. The method of claim 21, wherein the verification of the at least one account holder is done at a branch office of the at least one service point based on the reference number presented by the at least one account holder.

23. The method of claim 14, further comprising displaying a list of documents along with an availability of the documents within the storage repository, further wherein the documents are associated with the at least one account holder and are required for processing the service request.

24. A method for facilitating document transactions through a document banking system, the method comprising:
receiving a service request from a first account holder registered with the document banking system;
identifying at least one second account holder capable of processing the service request in a location associated with the first account holder, wherein the second account holder is registered with the document banking system;
identifying one or more documents along with their availability in the document banking system, wherein the documents are associated with the first account holder and are required for processing the service request;
adding the one or more documents in a transfer queue of the second account holder; and
transferring the at least one document in a document banking account of a second account holder based on one or more rules defined by the second account holder;
wherein the at least one document is transferred into the document banking account of the second account holder post verification of the first account holder by the second account holder.

25. The method of claim 24 further comprising transferring the one or more documents into the document banking account of the second account holder post verification of the first account holder by the second account holder.

26. The method of claim 25, wherein the verification of the first account holder is performed at a branch office of the second account holder based on the reference number presented by the first account holder.

27. The method of claim 24, wherein the first account holder logs into the document banking system by entering a universal resource locator in a browsing application on a device of the first account holder.

28. The method of claim 24, wherein the first account holder logs into the document banking system by entering one or more login credentials at a document banking application running on a device of the first account holder.
